(19) United States
(12) Patent Application Publication
(10) Pub. No.: US 2010/0192404 A1
(43) Pub. Date: Aug. 5, 2010

(54) Clothes dryer fire safeguard circuit with energized relay cutoffs

(76) Inventors: Antonino Maltese, Montreal (CA); Silvia Ionelia Prajescu, Dollard-des-Ormeaux (CA)

Correspondence Address: STEVEN W. SMITH, 4224 Hartlees Field Road, Denton, TX, 76208, US

(21) Appl. No.: 12/587,728

(22) Filed: Oct. 13, 2009

(30) Foreign Application Priority Data
Jan. 30, 2009 (CA) 2,651,546

(51) Int. Cl. F26B 21/00

(52) U.S. Cl. 34/524

(57) ABSTRACT

A dryer fire protection system has a control circuit for controlling power supplied from a source, via a power cord comprising a neutral line and at least one entry live line, to a load connected with the neutral line and at least one load live line. The control circuit has a relay comprising an electromagnet and a normally closed switch, when the electromagnet is de-energized, to allow power to flow between the entry live line and corresponding load live line. An electromagnet control circuit connected between the entry line and neutral line has a plurality of normally open thermostats in parallel and mounted within the cabinet external of a drum and ducting associated therewith. Power is normally disconnected from the electromagnetic circuit to de-energize the electromagnet. Excessive cabinet heat closes at least one thermostat to power the electromagnet circuit to energize the electromagnet to open the switch.

### CROSS-REFERENCE TO RELATED APPLICATION

This application is related to the US patent application entitled “CLOTHES DRYER FIRE SAFEGUARD CIRCUIT WITH DE-ENERGIZED RELAY CUTOFFS” (Dkt. No. CWC-274), U.S. Ser. No. ______ filed _______, commonly assigned to Mabe Canada, Inc.

### FIELD OF THE INVENTION

The present invention relates to a clothes dryer and, more particularly, to the strategic placement of temperature-dependent switches within the dryer cabinet which switches operate to disconnect power to the electrical wiring in the dryer and to reduce the risk of fire occurring in the dryer cabinet.

### BACKGROUND OF THE INVENTION

Clothes dryers typically circulate heated air through a rotating drum in order to remove the moisture from wet clothing placed therein. There has been a concern with respect to the build up of excess heat in the drum or in some areas of the dryer cabinet which can potentially cause a fire to occur in the dryer drum or within the cabinet itself.

U.S. Pat. No. 6,655,047 issued to Miller, II discloses a fire detection means which emits a signal that can trigger an electrical disconnect means in response to the signal. The electrical disconnect means de-energises the heat source and blower of the dryer. The disconnect means may comprise a fails-open relay, a switch or normally open solenoid valves. In a gas dryer, it may comprise normally closed solenoid valves. The electrical disconnect means can be located between the power cord and the source of electrical power to the dryer, within the dryer enclosure, within the main breaker box supplying power to the dryer, or within any of the other components receiving electrical power in the vicinity of the dryer. The detectors may also be located along the ventilation or exhaust path.

U.S. Pat. No. 6,715,216 issued to Salameh et al. teaches temperature detectors that can signal a controller to deactivate the heater, the motor and the blower when a fire condition is detected. The temperature detector may comprise a normally open bi-metal thermostat that can be positioned adjacent the drying chamber, such as at the inlet and the outlet of the drying chamber. The temperature detector sends a signal to the controller when a set point at the location of the detector has been reached or exceeded. It appears that some power must reach the dryer to run the controller even after a fire is detected.

Neither of U.S. Pat. No. 6,655,047 and U.S. Pat. No. 6,715,216 teaches the energization of a relay by thermostats to disconnect power to the dryer circuitry. Further, neither of these two documents teaches the strategic placement of the thermostats within the dryer cabinet in order to have fire protection means in specific areas of the dryer in which excess heat may accumulate.

As a result of testing done on domestic clothes dryers, it has been determined that excess heat may accumulate within the dryer cabinet, which can cause fires to occur within the dryer cabinet. The mere use of temperature detectors in dryer cabinet may not be sufficient to reduce the risk of fire due to excess heat accumulation. Further, the use of power disconnect devices external to the cabinet may be too slow or not sufficiently sensitive to disconnect power from the dryer when a fire condition is initially detected. Systems which require a signal to be sent to a control center which then disconnects power to the dryer are complex and may also have slow response times in the event of a fire detection. Further, such systems may supply power to the control center even after a fire is detected and power is disconnected from the components. Consequently there is a need in domestic clothes dryers to provide for a sensitive means of power disconnection to the dryer electrical load such that these high heat areas are strategically targeted for protection that results in a power disconnect to the electrical wiring in the cabinet.

### BRIEF DESCRIPTION OF THE INVENTION

The present invention relates to a clothes dryer and, more particularly, to the strategic placement of temperature-dependent switches which energize a relay upon detection of excess heat within the cabinet. The energized relay in turn disconnects power to the electrical load to reduce the risk of fire occurring in the dryer cabinet. The interruption of power to a relay using thermostats allows heat to be readily detected in one or possibly a plurality of areas within the dryer cabinet, while disconnecting power to the electrical load.

It is important to disconnect power to the clothes dryer electrical load in the event of a fire in the cabinet of the dryer to diminish the chances of a fire spreading outside of the dryer cabinet. Further, the disconnection of power during a fire condition may prevent arcing caused by heat damaged wires. Hence, it is advantageous to have as many potentially high heat areas in the cabinet protected in order to prevent the initiation of a fire condition.

In accordance with one embodiment of the present invention there is provided a clothes dryer comprising a cabinet and a dryer drum mounted within the cabinet. The dryer has ducting associated therewith for directing air flow into and through the dryer drum to dry clothing articles placed in the drum. The dryer further comprises a power cord for supplying power from a power source to an electrical load in the cabinet. The power cord comprises a cord neutral wire line and at least one entry live wire line which pass into the cabinet. The electrical load is connected in circuit with the power cord neutral wire line and at least one load live wire line. The dryer further comprises a control circuit for controlling the supply of power from the power source to the electrical load. The control circuit comprises a relay which comprises a switch positioned between the at least one entry live wire line and a corresponding load live wire line. The switch is normally biased closed to allow power to flow from the live wire entry line to the corresponding load live wire line. The relay comprises an electromagnet which, when energized opens the normally closed switch to disconnect power between the live wire entry line and the corresponding load live wire line . The dryer further comprises an electromagnet control circuit connected in circuit between at least one of the entry live wire lines and the cord neutral line. The electromagnetic control circuit comprises at least one temperature-sensing thermostat mounted within the cabinet external of the drum and associated ducting, the at least one temperature-sensing thermostat being normally open and closing in response to excessive heat in the cabinet. Power is normally disconnected from the electromagnet control circuit to de-energize the electromagnet to close the switch. Power flows through the electromagnet control circuit when the temperature sensing thermostat closes in response to excessive heat in the cabinet thereby energizing the electromagnet and opening the switch.

In an alternative embodiment of the present invention, the power cord is electrically connected to a terminal box mounted on the wall of the cabinet. One of the terminal box and the power cord has a cord neutral wire line and at least one entry live wire line. The neutral line is connected in electrical circuit with the electrical load.

In another alternative embodiment of the present invention, the electromagnet control circuit comprises a plurality of thermostats located in different areas of the cabinet and electrically connected in parallel. This arrangement provides the advantages wherein a plurality of locations within the cabinet may be protected simultaneously and only one of the temperature-dependent switches may be required to close to energise the relay to disconnect the electrical load from the power source.

In another embodiment, the cabinet further comprises a wiring entry opening through which the power cord neutral wire line and the at least one entry live wire line pass into the cabinet. The relay may be located adjacent the wiring entry opening. This permits power to be disconnected from the dryer at the point of entry of the power cord into the dryer. It is well known that a fire condition may cause damage to the wire coating protecting wires from short circuits. Short circuits have the potential to increase the risk of a fire condition. By disconnecting power at the point of entry, potential further damage caused by shorts along the power supply line are reduced or are avoided. The electrical load may comprise at least one motor and an electronic power supply.

### BRIEF DESCRIPTION OF THE DRAWINGS

For a more thorough understanding of the nature and objects of the present invention reference may be had, by way of example, to the accompanying diagrammatic drawings in which:

FIG. 1 is a perspective view of an exemplary clothes dryer that may benefit from the present invention;

FIG. 2 is a side sectional view of an exemplary clothes dryer that may benefit from the present invention;

FIG. 3 is a partial exterior view of the rear wall showing the connection of the power cord to an exemplary terminal block for an exemplary electric clothes dryer;

FIG. 4 is an electrical circuit diagram in accordance with the present invention;

FIG. 5 is an electrical schematic diagram for an exemplary clothes dryer heated by one or more electrical heating elements;

FIG. 6 is an electrical schematic diagram for and exemplary clothes dryer heated by a gas heater; and,

FIG. 7 is an interior perspective of the exemplary clothes dryer showing the rear wall of the clothes dryer cabinet with the rotating drum removed.

### DETAILED DESCRIPTION OF THE INVENTION

The present invention relates to a clothes dryer and, more particularly, to the strategic placement of temperature-dependent switches which connect power to a relay, upon detection of excess heat within the dryer cabinet. The connected relay in turn disconnects power to the electrical load to reduce the risk of fire occurring in the dryer cabinet.

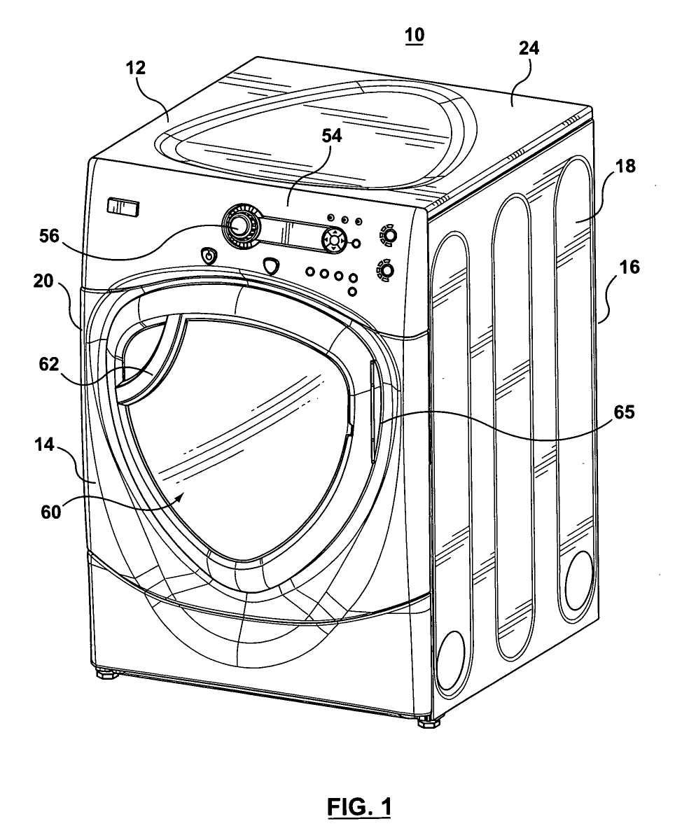

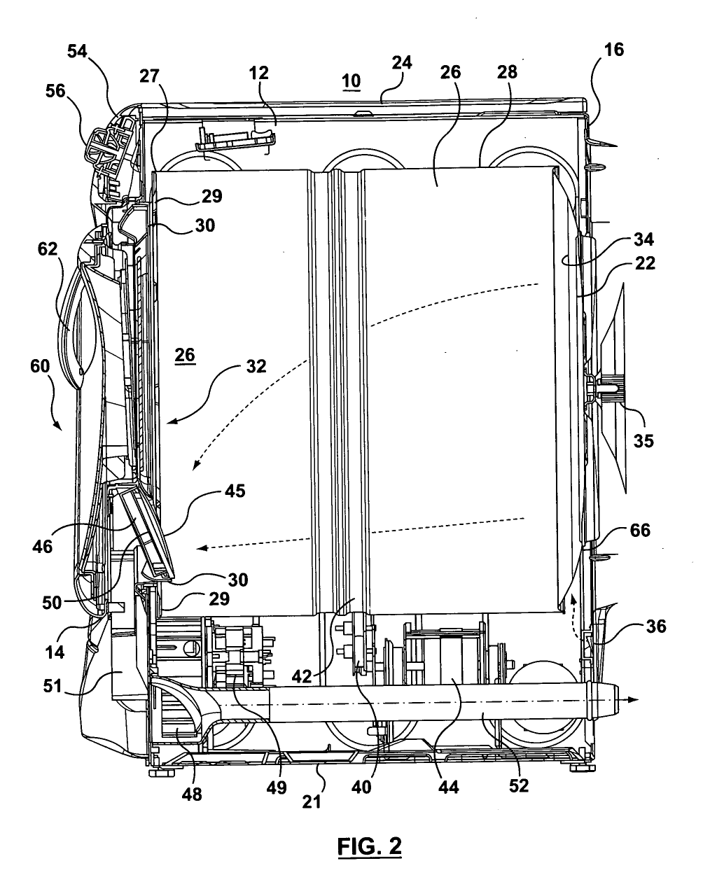

Referring to FIGS. 1 and 2, there is shown an exemplary clothes dryer 10 which may benefit from the present invention. The clothes dryer 10 comprises a cabinet or a main housing 12 which further comprises a front wall 14, a rear wall 16 and side walls 18, 20 spaced apart from each other by the front and rear walls, a floor 21 and a top cover 24.

Within the cabinet 12 is a drum or container 26 mounted for rotation around a substantially horizontal axis. A motor 44 rotates the drum 26 about the horizontal axis through, for example, a pulley 40 and a belt 42. The drum 26 is generally cylindrical in shape, has an outer cylindrical wall 28, and has an open end 27 that typically comprises a metal ring 29 attached by welding to the drum 26 for reducing the diameter of the opening of the drum 26 to match a front bulkhead wall or front bearing 30. The bearing 30 further defines an opening 32 into the drum 26. Clothing articles and other fabrics are loaded into the drum 26 through the opening 32. A plurality of tumbling ribs (not shown in figures) are provided within the drum 26 to lift the articles and then allow them to tumble back to the bottom of the drum as the drum rotates.

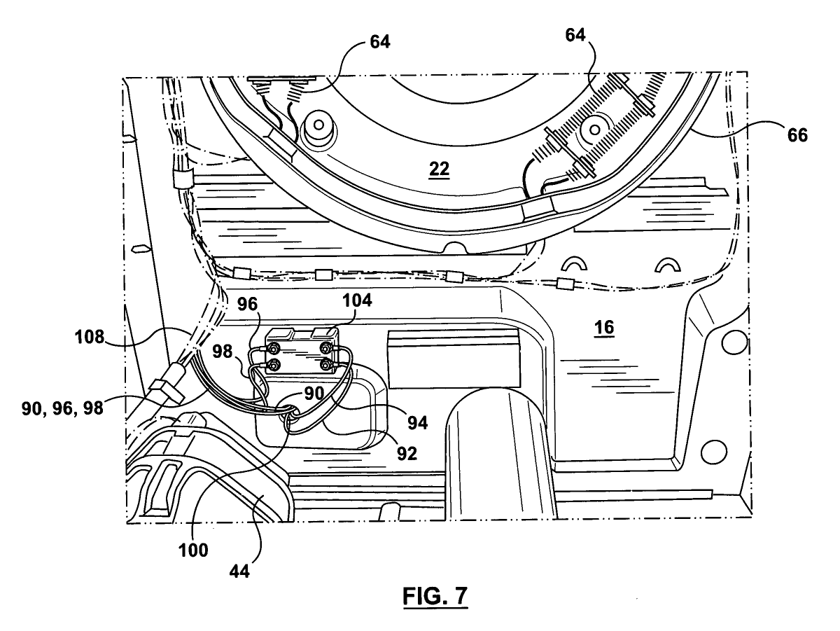

The drum 26 includes a drum rear wall 34 rotatably supported within the main housing 12 by bearing 35. The drum rear wall 34 includes a plurality of holes (not shown) that receive hot air that has been heated by a heater comprising electrical heating elements 64 (FIG. 7) located in heater housing 22. The heater housing 22 receives ambient air passing through an inlet or louvres 36 and into the heater housing around circular flange 66 of the heater housing 22.

Although the exemplary clothes dryer 10 shown in FIG. 1 is an electric dryer having electrical heating elements 64 that warm the ambient air, it should be understood that the dryer may be a gas dryer having a gas burner for heating ambient air entering the dryer. The gas burner may be located below the drum 26 and have ducting extending from the gas burner up to the drum rear wall 34.

Air heated by the heater is drawn into and from the drum 26 by a blower fan 48 which is also driven by a second motor 49 in the embodiment shown. In an alternative embodiment, motor 44 may be used to drive blower fan 48. Air is drawn by the blower fan 48 from the heater housing 22, into, through and out of the drum 26, through a grill 45 and screen filter 46. Grill 45 keeps clothing articles tumbling in the drum 26 from contacting the filter 46 and touching the lint trapped by the filter 46 within the trap duct 50. As the air passes through the screen filter 46, it flows through lower duct portion 51 and is blown by blower wheel 48 attached to motor 49 out of the clothes dryer 10 through an exhaust duct 52. In this embodiment, the drum 26 is in air flow communication with the trap duct 50 whose lower duct portion 51 has an outlet that is in air flow communication with the blower wheel 48 and the exhaust duct 52. The exhaust duct 52 passes through the rear panel 16 and is usually connected to suitable venting (not shown) that vents the air outdoors.

After the clothing articles have been dried, they may be removed from the drum 26 via the opening 32. Opening 32 is shown closed by a window or port-hole like door 60. Door 60 has a handle 62 for pivotally opening the door about hinge 65.

The dryer 10 is shown to have a control panel 54 with touch and or dial controls 56 that permit the user to control operation of dryer 10.

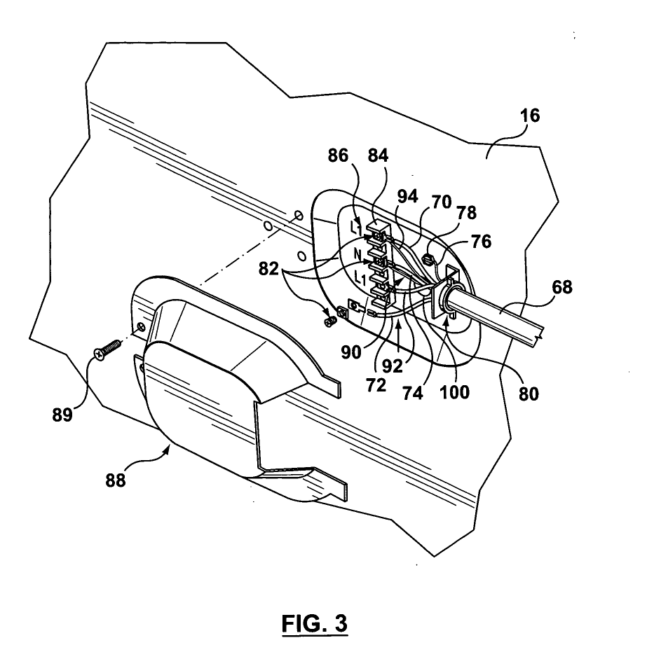

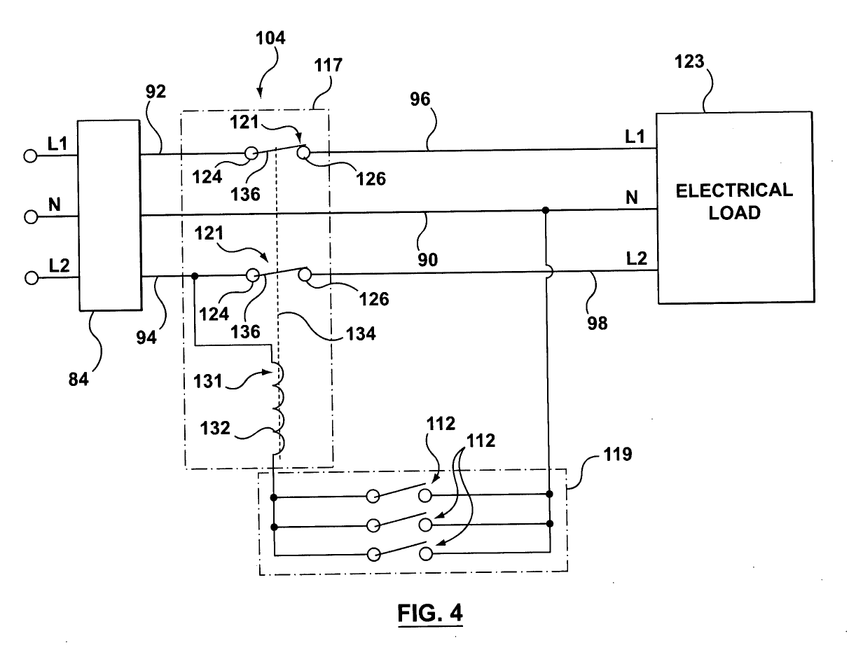

Referring to FIGS. 3 and 4, the wiring circuitry for clothes dryer 10 is shown. Power is supplied to the dryer in FIG. 3 from a power source (not shown in figures) by a power cord 68. Power cord 68 has two live power lines 70 and 72 a neutral wire line 74 and a ground wire 76. Ground wire 76 is shown connected by a screw 78 to the rear wall 16 of the clothes dryer 10. The wire lines 70, 72, 74 and 76 of the power cord 68 are rated for 120/240 volts and 30 amps. The power cord 68 is connected to the dryer rear wall 16 through a strain relief bracket 80. The live wire lines 70 and 72 as well as the neutral wire line 74 are connected by screws 82 to separate connection terminals in terminal block 84 of the terminal block assembly 86. A cover 88 is fastened by screw 89 to the rear wall 16 to cover the terminal block assembly 86. The terminal block 84 is shown mounted to the outside of the rear wall 16.

In FIGS. 3 and 7, a dryer neutral wire line 90 and two dryer entry live wire lines 92 and 94 pass through a wiring entry opening 100 located in the rear panel 16 of the dryer 10. Wires 90, 92 and 94 enter the dryer cabinet 12 through the opening 100. The dryer entry live wires 92 and 94 are respectively connected in electrical circuit with corresponding load live wire lines 96 and 98 via control circuit 117 (FIG. 4) and electromagnet control circuit 119 (FIG. 4). Load live wire lines 96 and 98 together with neutral line 90 are connected in a wiring harness 108 (FIG. 7) to provide power to various loads within the clothes dryer cabinet including for example motor 44 and heating elements 64 of heater housing 22. This electrical load is shown schematically in FIG. 4 at numeral 123. It should be understood that the wiring harness 108 will also provide power to a power supply for the electronic components for the clothes dryer 10.

Control circuit 117, as shown in FIG. 4, is for controlling the supply of power from the power source to the electrical load 123. Relay 104, of control circuit 117, comprises an electromagnet 131 and switches 121 and is connected in electrical circuit between the dryer entry live wire lines 92, 94 and corresponding dryer load live wire lines 96, 98. In the preferred embodiment, electromagnet 131 is connected in electrical circuit between the live wire entry lines 92, 94 and the neutral wire line 90. Electromagnet 131 comprises a hollow electromagnetic coil 132 wound about at least a portion of an actuator 134 which comprises an iron rod or plunger that is moveable relative an axis of the coil 132. Switches 121 are located between each live wire entry line 92, 94 and their respective corresponding load live wire line 96, 98. The switches 121 each comprise contacts 124, 126 and a shorting bar 136 that is perpendicularly coupled with the actuator 134. Contact 124 corresponds to an end of live wire entry line 92 or 94 and contact 126 corresponds to an end of load live wire line 96 or 98. The shorting bar 136 spans the breadth between contacts 124 and 126 to bridge the contacts in electrical circuit when the electromagnet 131 is de-energized. The switches 121 are normally biased closed by a spring or spring effect (not shown) to connect power between each of the live wire entry lines 92, 94 and the corresponding load live wire lines 96, 98. The spring exerts a force that opposes the electromagnetic force exerted by the energized electromagnet 131. When the electromagnet 131 is de-energized the spring exerts its force on the actuator 134 to close the shorting bars 136 across contacts 124 and 126. As a result, the dryer entry live wire lines 92, 94 and the dryer load live wire lines 96, 98 are connected and supply of power from the power source is connected with the electrical load. The electromagnet 131, when energized, exerts a force which overpowers the force of the spring. Thus, when the electromagnet 131 is energized, the actuator 134 is attracted further into or towards the coil 132 and the bridge made by the shorting bar 136 across contacts 124 and 126 is lifted or broken, opening the switches 121. Thus, the dryer load live wire lines 96, 98 are disconnected from electrical circuit. It should be understood that other types of electrical relays having different actuating configurations may be used in the present invention and should not be limited solely to the embodiment described.

Referring still to FIG. 4, the electromagnet control circuit 119 comprises a plurality of temperature-sensing thermostats 112 arranged in parallel and connected in electrical circuit with the relay 104 between at least one entry live wire line 92, 94 and the power cord neutral line. Each thermostat 112 is normally open (as shown) and closes in response to the detection of excess heat. Typically, the thermostat comprises a bimetal element that changes position at a predetermined temperature to close circuit the thermostat. While power is normally disconnected from the electromagnet control circuit 119 to de-energize the electromagnet 131, when the predetermined temperature is reached or exceeded near one of the thermostats 112, that thermostat 112 closes, energizing the electromagnet 131 and opening the relay 104.

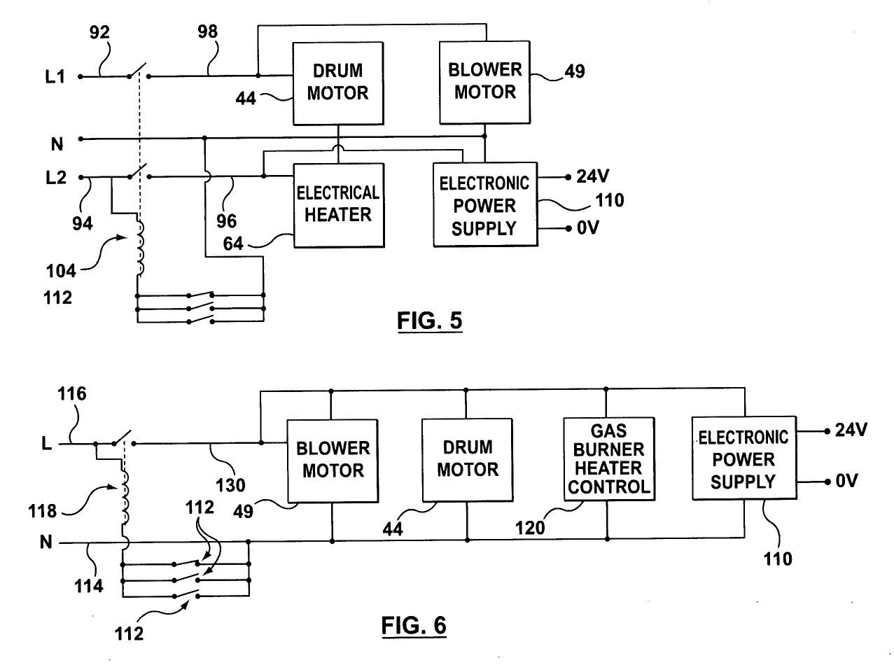

Referring to FIG. 5, the distribution of the power to the loads 44, 49, 64 and 110 in the dryer drum is shown. Relay 104 is connected in electrical circuit between the dryer entry live wire lines 92, 94 and corresponding dryer load live wire lines 96, 98 to control the supply of power from the power source to the electrical load.

During the operation of the dryer 10, heat may accumulate in excess in areas within the dryer cabinet 12. Heat may be caused, for example, by the operation of the motor 44 or the heating elements 64. Spaces within the cabinet 12 that are prone to excessive heat accumulation or to a fire condition are determined through testing. For optimal protection, adjacent or within each space may be located a thermostat 112. Accordingly, although a plurality of thermostats 112 are shown in FIGS. 4 and 5, it should be understood that the present invention can function with only one thermostat 112 located within the cabinet 12. As shown in FIG. 5, in the event of an excess heat or fire within the cabinet 12, at least one thermostat 112 closes to disconnect the relay 104 from the power source. This, in turn, opens the circuit between the dryer entry live wire lines 92 and 94 and corresponding dryer load live wire lines 96, 98 to disconnect the electrical load from the power source, terminating dryer operation.

The placement of the relay 104 is preferably close to the wiring entry opening 100. As shown in FIG. 7, this limits the length of wires 92, 94 unprotected by the relay that extend within the cabinet to a short distance. In the event of a fire or excess heat condition, this may limit the amount of wire that may arc due to deterioration of the wires caused by the heat. This serves to reduce the risk of a potential fire inside the dryer cabinet.

It should be understood that for a gas dryer, the amount of power to the dryer is reduced since the heating is achieved by combustion of natural gas or propane gas, and not by electrical heating elements. As a result, wiring for this arrangement typically comprises one power line and one neutral line entering into the dryer drum and rated at 120V and 15 Amps. A power cord connected to the dryer includes a power line, a neutral line and a grounding wire line. The grounding wire is grounded to the chassis or cabinet 12 of the clothes dryer 10. A terminal box is used similar to that shown in FIG. 3, or alternatively, the power cord is connected directly through a strain relief bracket to the dryer so that the live wire line and the neutral wire line of the power cord pass directly through a wire entry opening into the clothes dryer cabinet. The relay is located closely adjacent to the entry opening so as to minimize the length of unprotected live wire line of the power cord within the dryer cabinet. A schematic representation of the wiring diagram or such a system is shown in FIG. 6 wherein the entry live wire line 116 and the neutral wire line 114 are provided for supplying power to the blower motor 49, the drum motor 44, the gas burner 120, and the electronic power supply 110. Relay 118 is located in the circuit to disconnect power to the load live wire line 130 and the load 49, 44, 120, and 110.

While the invention has been described in terms of various specific embodiments, those skilled in the art will recognize that the invention can be practiced with modifications within the scope of the present invention as disclosed herein.

What is claimed is:

1. A clothes dryer comprising:
a cabinet;
a dryer drum mounted within the cabinet and ducting associated therewith for directing air flow into and through the dryer drum to dry clothing articles placed in the drum;
a power cord for supplying power from a power source to an electrical load in the cabinet, the power cord comprising a cord neutral wire line and at least one entry live wire line which pass into the cabinet;
the electrical load being connected in circuit with the power cord neutral wire line and at least one load live wire line;
a control circuit for controlling the supply of power from the power source to the electrical load, the control circuit comprising a relay, the relay comprising a switch positioned between the at least one entry live wire line and a corresponding load live wire line, the switch being normally biased closed to allow power to flow from the live wire entry line to the corresponding load live wire line, and the relay comprising an electromagnet which when energized opens the normally closed switch to disconnect power between the live wire entry line and the corresponding load live wire line; and,
an electromagnet control circuit connected in circuit between at least one of the entry live wire lines and the cord neutral line, the electromagnet control circuit comprising at least one temperature-sensing thermostat mounted within the cabinet external of the drum and associated ducting, the at least one temperature-sensing thermostat being normally open and closing in response to excessive heat in the cabinet, power normally disconnected from the electromagnet control circuit to de-energize the electromagnet to close the switch and power flowing through the electromagnet control circuit when the temperature sensing thermostat closes in response to excessive heat in the cabinet thereby energizing the electromagnet and opening the switch.

2. The clothes dryer as in claim 1 wherein:
the electromagnetic control circuit comprises a plurality of thermostats located in different areas of the cabinet and electrically connected in parallel.

3. The clothes dryer as in claim 1 wherein:
the cabinet further comprises a wiring entry opening through which the power cord neutral wire line and the at least one entry live wire line pass into the cabinet.

4. The clothes dryer as in claim 3 wherein:
the relay is located adjacent the wiring entry opening.

5. The clothes dryer as in claim 1 wherein:
the electric load comprises at least one motor and an electronic power supply.

6. A clothes dryer comprising:
a cabinet;
a dryer drum mounted within the cabinet and ducting associated therewith for directing air flow into and through the dryer drum to dry clothing articles placed in the drum;
a power cord for supplying power to the dryer from a power source, the power cord being electrically connected to a terminal box mounted on the wall of the cabinet, one of the terminal box and the power cord having a cord neutral wire line and at least one entry live wire line, the neutral line being connected in electrical circuit with an electrical load;
the electrical load being connected in circuit with at least one load live wire line;
a control circuit for controlling the supply of power from the power source to the electrical load, the control circuit comprising a relay, the relay comprising a switch positioned between the at least one entry live wire line and a corresponding load live wire line, the switch being normally biased closed to allow power to flow from the live wire entry line to the corresponding load live wire line, and the relay comprising an electromagnet which when energized opens the normally closed switch to disconnect power between the live wire entry line and the corresponding load live wire line ; and,
an electromagnet control circuit connected in circuit between at least one of the entry live wire lines and the cord neutral line, the electromagnet control circuit comprising at least one temperature-sensing thermostat mounted within the cabinet external of the drum and associated ducting, the at least one temperature-sensing thermostat being normally open and closing in response to excessive heat in the cabinet, power normally disconnected from the electromagnet control circuit to de-energize the electromagnet to close the switch and power flowing through the electromagnet control circuit when the temperature sensing thermostat closes in response to excessive heat in the cabinet thereby energizing the electromagnet and opening the switch.

7. A clothes dryer as in claim 6 wherein:
the electromagnet control circuit comprises a plurality of thermostats located in different areas of the cabinet and electrically connected in parallel.

8. The clothes dryer as in claim 6 wherein:
the cabinet further comprises a wiring entry opening through which the power cord neutral wire line and the at least one entry live wire line pass into the cabinet.

9. The clothes dryer as in claim 8 wherein:
the relay is located adjacent the wiring entry opening.

10. The clothes dryer as in claim 6 wherein:
the electric load comprises at least one motor and an electronic power supply.
